(19) United States
(12) Patent Application Publication
(10) Pub. No.: US 2011/0283478 A1
(43) Pub. Date: Nov. 24, 2011

(54) DAMPENING DEVICE AND SYSTEM

(75) Inventors: Bret Berry, Tallahassee, FL (US); Jeremy Higginson, Salt Lake City, UT (US); Adam Pike, Jacksonville, FL (US)

(73) Assignee: GLOBAL SAFETY DEVICES, LLC, Bountiful, UT (US)

(21) Appl. No.: 12/784,288

(22) Filed: May 20, 2010

(51) Int. Cl. E05F 3/04; F16F 9/02; F16F 7/00; F16F 9/30; E05F 3/20; E05F 3/02

(52) U.S. Cl. 16/54; 16/50; 16/68; 267/136; 267/141; 267/124

(57) ABSTRACT

A dampening device for use in a dampening system that operates to dampen and slow the movement of a closing door thereby reducing noise and the risk of injury, the dampening device including a piston and dampening apparatus that are moveable within a cylinder and an anchoring apparatus, the dampening device attached to various positions along a door frame or door panel.

### BACKGROUND

The present invention relates to a dampening device for use in a dampening system that operates to dampen and slow the movement of a closing door thereby reducing noise and the risk of injury to users, particularly children. The dampening device includes a piston and dampening apparatus that are moveable within a cylinder and an anchoring apparatus, the dampening device attached to various positions along a door frame or door.

Typical door systems employ a door that is sized and shaped to fit within a door frame that is connected to the door via one or more hinges. Normally, the door can swing freely about the hinges in an opening and closing movement.

The motion of closing and opening the door carries a potential risk of injuring persons as the door is in motion and comes to stop within the door frame. For example, a part of a person's body (especially that of a child's) part may become trapped between the door and door frame as the door is closed. The degree of potential injury differs depending upon how fast and how much force the door exerts as it is closed. Much of the potential injury and damage occurs when the door comes to a stop within the door frame.

The motion of closing the door also may create undesired noise as the door is closed and comes to rest within the door frame. Often, users will slam a door shut, causing a loud bang as the door comes to a stop. This is especially problematic in rooms when silence is desired.

Devices are available to control the closing motion of the door. For example, hydraulic door closers use hydraulic pressure to resist the forces exerted by the moving doors and function to slow the door from closing too fast and loudly. However, hydraulic door closers are typically large and difficult to install. Furthermore, hydraulic door closers have many moving parts that may break or malfunction. The purchasing and installing of hydraulic door closers may be cost prohibitive to many users, and thus the users may forego installing such safety devices.

Therefore, there is a need in the art for a device and system for slowing the movement of the door as it is closed and reducing the noise created by the closing door. A device is needed that can absorb some of the forces exerted as the door is being closed and/or resist the motion of the closing door.

### SUMMARY OF THE INVENTION

One or more embodiments of the present invention provide a dampening system that employs a dampener designed to dampen, resist and reduce the amount of speed and force of a door panel as it is being shut.

An important consideration of the dampening system of the present invention is the placement and installation of the dampener in a door panel or door jamb. It is contemplated that the installation of the dampener can be accomplished by a user without the need for special tools or hiring a building contractor. The dampener may be integrated with an existing door panel or door frame. Placement and installation of the dampener by a user may be easily and quickly accomplished by replacing one of the hinge screws with a suitably sized dampener. A user may also choose to drill a hole into the door panel or door frame that is sized to receive and secure the dampener.

In accordance with at least one aspect of the present invention, a selection of dampeners having different dampening forces may be provided to the user such that a user may select a suitable dampener depending on how much reduction in the speed of the closing door is desired. The dampening forces determine how much dampening effect the dampener has on the closing door. Preferably, the dampening forces of the dampener may be large enough to slow, but not completely stop, the door as it is being closed. As such, different dampening forces are needed depending on the size and weight of the door panel. To vary the amount of dampening force, the dampening apparatus may take various shapes and forms (see discussion below).

In accordance with one or more embodiments of the present invention, a dampening system includes: a door frame having a hinged jamb; a door panel, having a hinged edge, that is suitably sized to fit within the door frame; a hinge that connects the door panel and door frame together and operates to allow the door panel to move relative to the door frame; and at least one dampener having a cylinder, a piston and a compressible dampening apparatus moveable within said cylinder. The dampener may be inserted into a hole located in the door panel or door frame. The dampening system operates to dampen and slow a closing motion of the door panel about the hinge whereby the dampener moves from a resting position to a compressed position as a force created by the moving door panel is exerted upon the dampener.

The orientation of the dampener in the resting position may be such that the piston extends out of the cylinder and the dampening apparatus is decompressed. The orientation of the dampener in the compressed position may be such that the piston retracts into the cylinder and the dampening apparatus compresses as the force created by the moving (i.e., as the door is pushed or pulled closed) door panel is exerted upon the dampener. For example, as the door is being closed, the hinged edge contacts the piston. As the door continues to be closed, the piston is forced into the cylinder which, in turn, causes the dampening apparatus to compress. As the dampening apparatus becomes compressed, the compression creates a resistance force against the forces exerted by the moving door and dampens and slows the movement of the door. As the force exerted by the closing door is released (i.e., as the door is pushed or pulled open) the piston extends out of the cylinder and the dampening apparatus decompresses back to the resting position.

It is further contemplated that an anchoring apparatus may be integrated with a portion of an outer surface of the cylinder. The anchoring apparatus operates to secure the dampener within the hole and prevent or reduce the risk of the dampener falling away. The anchoring apparatus may include a plurality of spaced apart ridges along a portion of the outer surface. Alternatively, the anchoring apparatus may include a screw thread.

It is further contemplated that the cylinder of the dampener includes a chamber having a sealed end and an opposing open end, and the piston of the dampener includes a piston rod having a widened end and an opposing piston head end. The chamber may be sized and shaped to receive and allow the movement of the dampening apparatus and the widened end and a portion of the piston rod and piston head within. The widened end of the piston may be sized and shaped so that the widened end is in contact with an interior surface of the chamber. The piston rod and piston head are smaller than both the widened end and the interior surface of the chamber so that no contact is made as the piston rod and piston head move within the chamber. The cylinder, dampening apparatus and piston may be oriented so that the dampening apparatus is situated between the sealed end of the chamber and the widened end of the piston.

It is also contemplated that the open end of the chamber may include an inner flange that is sized to receive and guide the piston rod and piston head in and out of the chamber. The inner flange also operates to block the widened end of the piston from falling away from the chamber.

Additionally, the open end of the chamber may include an outer flange having a larger diameter than the cylinder. The outer flange operates to properly position the dampener in the hole and to prevent the dampener from being inserted too far into the hole.

It is further contemplated that the dampening apparatus may take various shapes and forms. The various shapes and forms operate to provide different amounts of resistance that is created as the dampening apparatus is compressed, and therefore, the dampening effect of the dampener. For example, the dampening apparatus may include a compression spring. The compression spring may be oriented such that one end of the spring is in contact with the closed end and the opposite end of the spring is in contact with the widened end. Various compression springs having different amounts of stored mechanical energy may be used depending on how much resistance is desired to dampen and slow the closing door.

Alternatively or additionally, the dampening apparatus may include a compressible material such as one or a combination of foams, sponges, fluids, gases, silicone, latex, silicone rubber, thermoplastic elastomer and rubber. The compressible material may fill a portion or the entirety of the chamber. The compressible material used may be selected upon how much resistance is desired to dampen and slow the closing door.

Alternatively or additionally, the dampening apparatus may include at least two magnets. In one embodiment, a first magnet is attached to the sealed end of the chamber and a second magnet is attached to the widened end of the piston. The magnets are oriented to one another such that like poles are facing each other. The magnets operate to repel one another, and therefore create resistance, as the widened end is compressed towards the closed end. The resistance created dampens and slows the closing door.

It is further contemplated that the chamber may be an enclosed environment. The enclosed environment operates to contribute additional resistance as the dampener is compressed. As the dampening apparatus compresses and the piston retracts into the cylinder, the air within the chamber also becomes compressed thereby creating a pressurized environment. The pressurized environment creates resistance against the forces exerted by the closing door and thus functions to contribute to the dampening and slowing of the closing door. In this embodiment it is further contemplated that the widened end may include a channel sized to receive a gasket that snugly contacts the interior surface of the chamber thereby creating an air tight seal.

It is further contemplated that the cylinder may include one or more perforations that operate to open the chamber to ambient pressure. As the dampening apparatus is compressed and the piston retracts into the cylinder, any displaced air within the chamber may escape through the perforations.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a schematic view of a dampening system employing a dampener in accordance with at least one aspect of the present invention.

FIG. 2A is a perspective view of a dampener device in accordance with at least one embodiment of the present invention in the resting position.

FIG. 2B is a perspective view of a dampener device in accordance with at least one embodiment of the present invention in the compressed position.

FIG. 2C is a perspective view of a dampener device in accordance with at least one embodiment of the present invention in the resting position.

FIG. 2D is a perspective view of a dampener device in accordance with at least one embodiment of the present invention in the resting position.

FIG. 3A is a section view along line A-A of the dampener device of FIG. 2A.

FIG. 3B is a section view along line B-B of the dampener device of FIG. 2B.

FIG. 3C is a section view along line A-A of the dampener device of FIG. 2A.

FIG. 3D is a section view along line A-A of the dampener device of FIG. 2A.

FIG. 4A is a perspective view of a dampener device in accordance with at least one embodiment of the present invention in the resting position.

FIG. 4B is a section view along line C-C of the dampener device of FIG. 4A.

FIG. 5 is a side view of a dampener device connected to a door hinge and hinged door jamb in accordance with at least one embodiment of the present invention.

FIG. 6 is a side view of a dampener device situated in a door jamb in accordance with at least one embodiment of the present invention.

### DETAILED DESCRIPTION OF THE PRESENT INVENTION

For the purposes of describing various aspects of the present invention, reference may be made to using a dampener device in a dampening system of an entry/exit door. It will be appreciated by those skilled in the art, however, that the various embodiments of the dampener device described and claimed herein may have application to many other areas, including furniture, cabinetry, vehicles such as cars, trucks, vans, buses, trains, aircraft, boat, motor vehicles or the like.

In particular, the dampener device of the present invention is directed to dampen and slow down the movement of a closing door and prevent the slamming shut of the door.

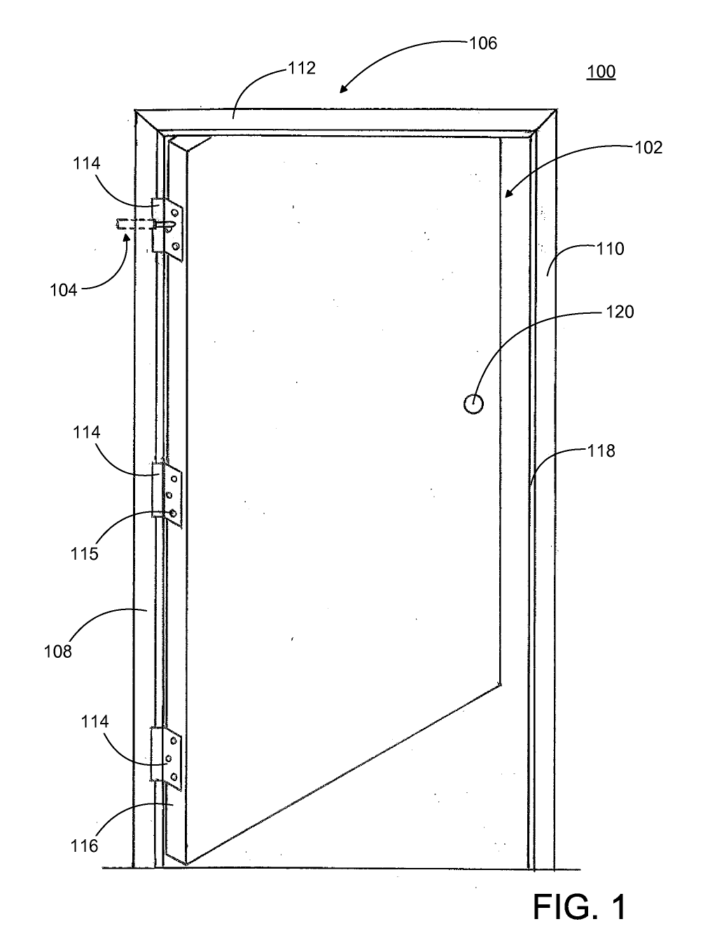

FIG. 1 is a schematic view of a dampening system 100 employing a dampener device 104 in accordance with at least one aspect of the present invention. The dampening system 100 may be for an entry and exit door or any of the aforementioned other applications. The dampening system 100 is operable to dampen and slow down the movement of a door that is moveable about a hinge connected to a door frame and prevent the slamming shut of the door. The dampening system includes a door panel 102, at least one dampener device 104, a door frame 106 having a hinged door jamb 108, an unhinged door jamb 110 and a rail 112, and at least one hinge 114. The hinge 114 functions to connect the door 102 and door frame 106 such that one side of the hinge 114 may be coupled to the hinged door jamb 108 via one or more screws 115 and another side of the hinge 114 may be coupled to a hinged door edge 116 of the door 102 via one or more screws 115.

In some embodiments, the dampening system 100 may further include a door stop 118 and a door knob assembly 120. The door stop 118 may line the door frame 106 along the door jambs 108 and 110 and the rail 112 and functions to position the door 102 in the closed position. Likewise, the door knob assembly 120 functions to hold and/or lock the door 102 closed.

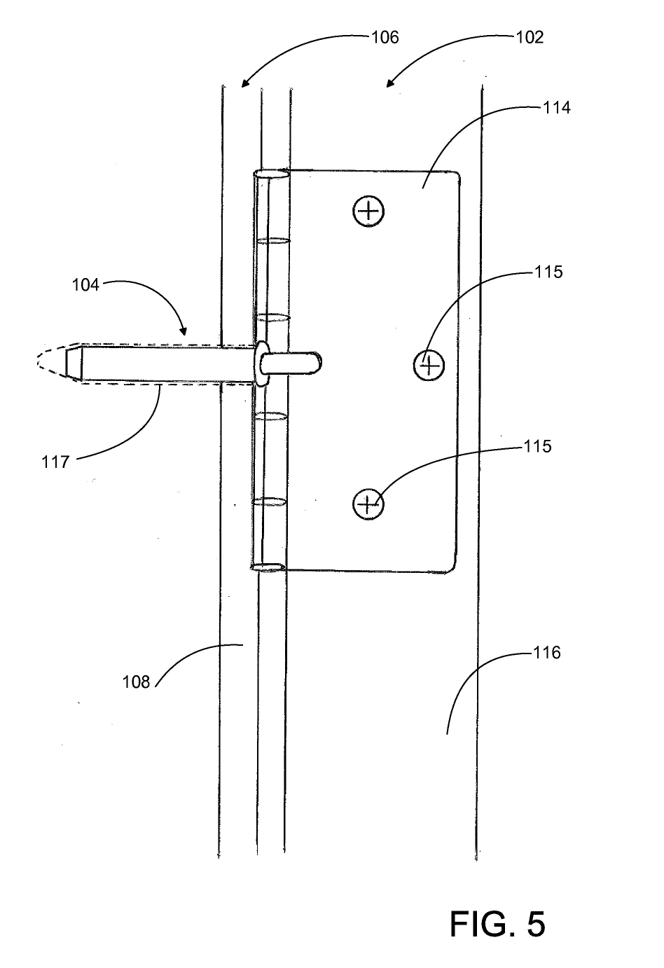

In one embodiment, the dampener device 104 may be coupled to and inserted within a screw hole recess 117 (see FIG. 5) which previously held one of the screws 115 of the hinge 114. For example, the dampener device 104 may be sized and shaped to snugly fit into the screw hole recess 117 of the hinge 114 connected to the hinged door jamb 108.

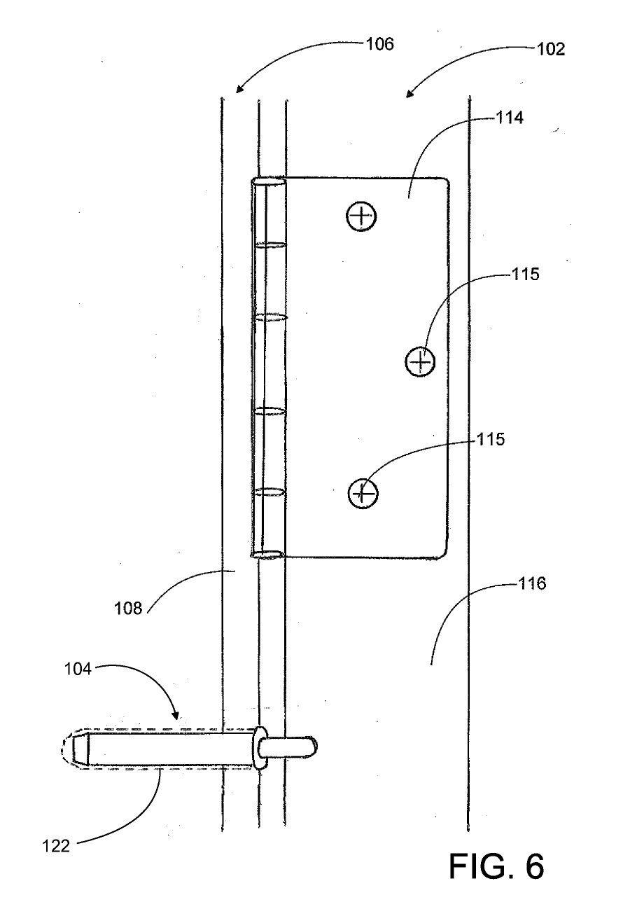

In another embodiment, the dampener device 104 may be coupled to and inserted within a recess 122 (as discussed below in FIG. 6), the recess 122 sized to receive and hold the dampener device 104. The recess 122 may be located on the hinged door jamb 108 at any position other than the hinge 114 as the recess 122 may be a specifically made drilled hole to receive and hold the dampener device 104.

In another embodiment, the dampener device 104 may be coupled to the door 102. For example, the dampener device 104 may be sized and shaped to snugly fit into one of the screw holes 117 which previously held one of the screws 115 of the hinge 114 connected to the edge 116 of the door 102. In another example, the dampener device 104 may be sized and shaped to snugly engage a recess (not shown, but is similar to the recess 122 of hinged door jamb 108) located on the hinged door edge 116, the recess sized to receive and hold the dampener device 104. The recess may be located on the edge 116 at any position other than the hinge 114 as the recess may be a specifically made to receive and hold the dampener device 104.

In accordance with one or more aspects of the present invention, the dampener device 104 is operable to dampen and slow the movement of the door 102 as the door 102 is closing. As will be discussed in more detail later in this description, this is accomplished by providing a dampening functionality at the dampener device 104, which comes into contact with the moving hinged door edge 116 as the door 102 is being closed. Once in contact, the moving door 102 exerts a force upon the dampener device 104. As a consequence, the exerted forces compress the dampener device 104. The compression creates resistance by the dampener device 104 against the exerted forces thereby dampening and slowing the motion of the door 102 from closing too fast and/or loudly.

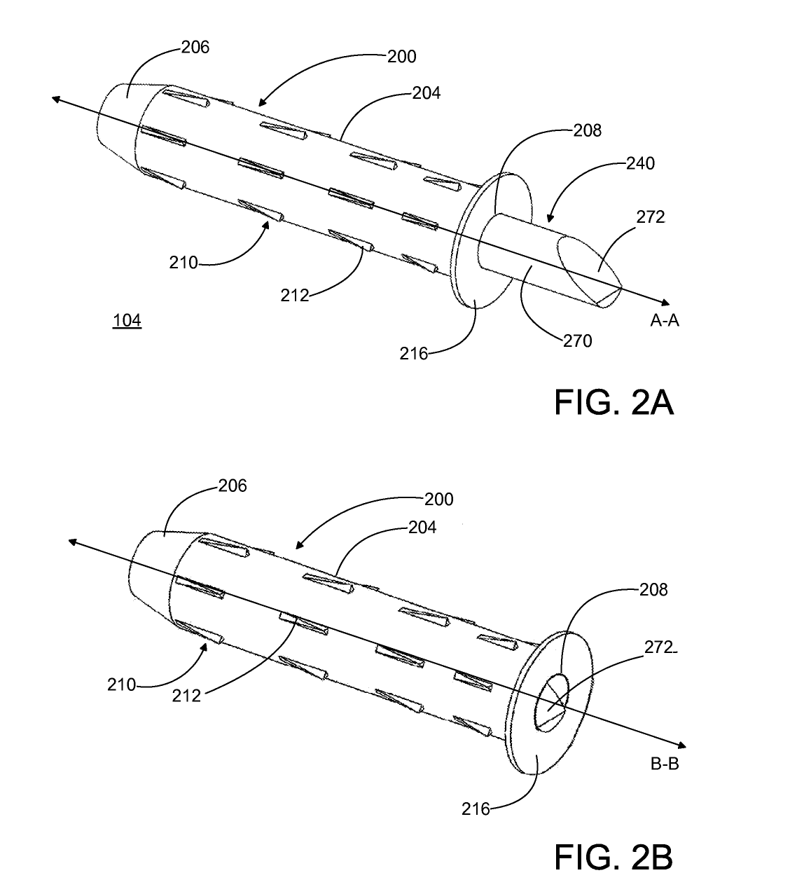

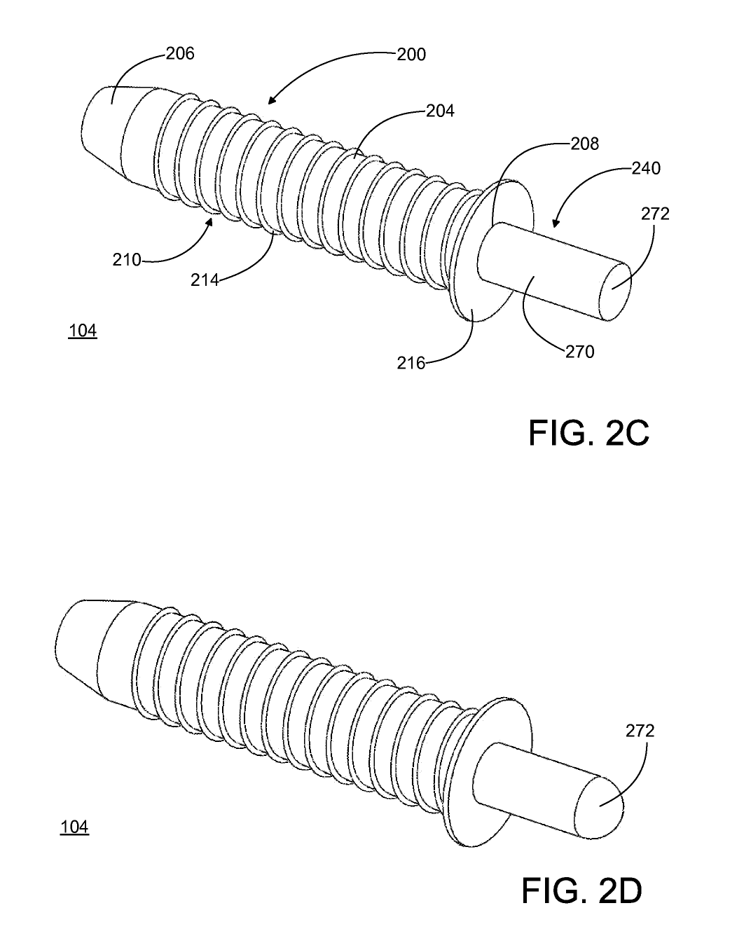

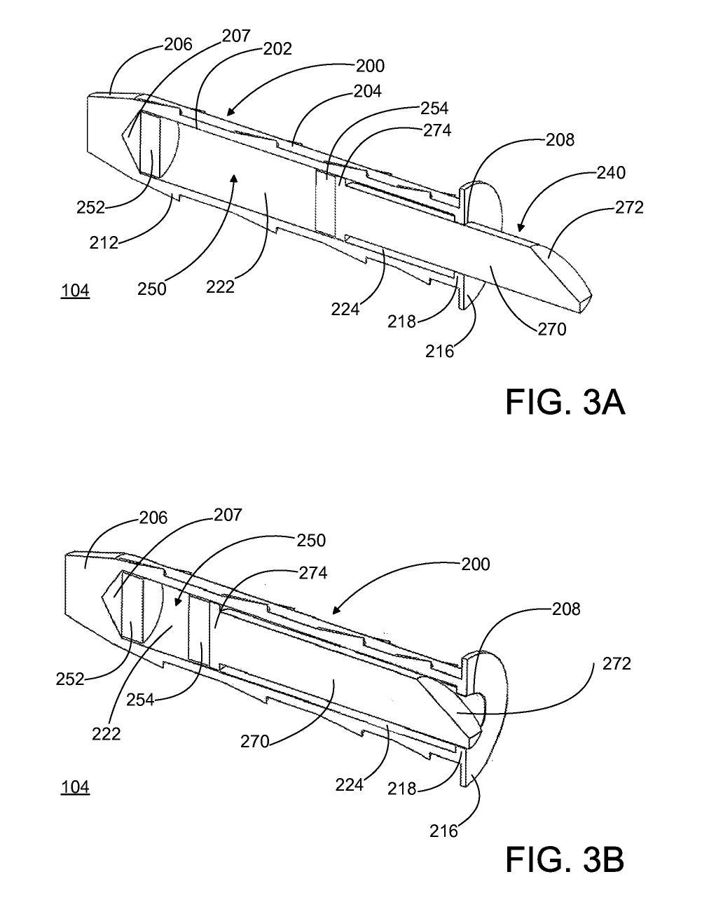

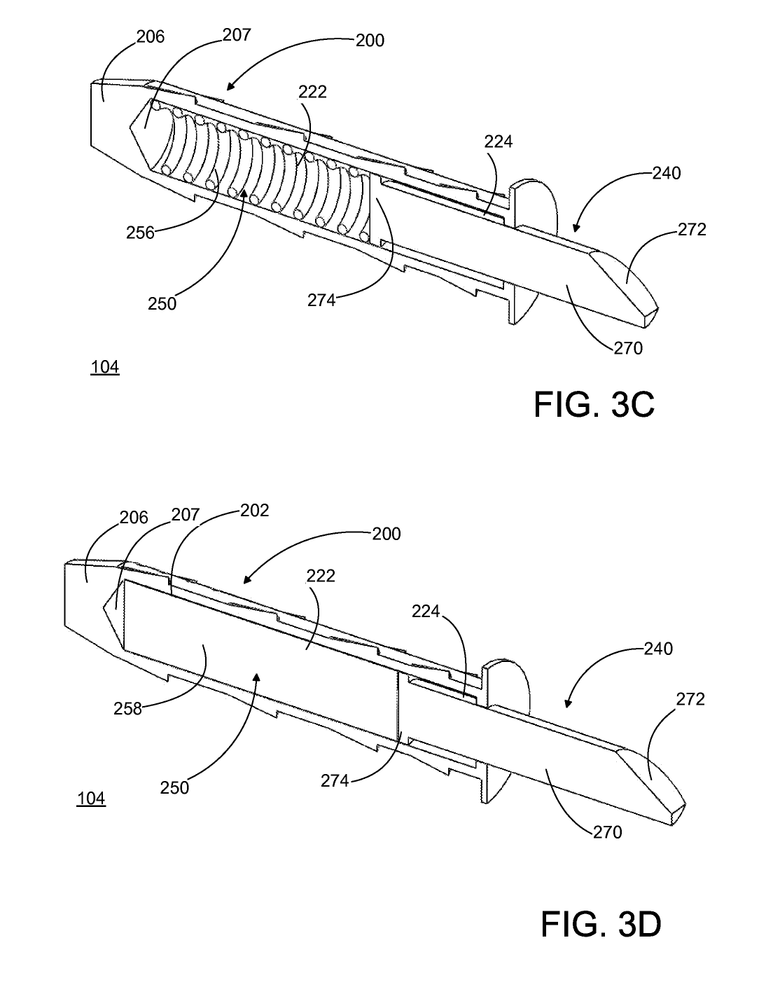

Reference is now made to FIGS. 2A and 2B, which are perspective views of the dampener device 104 in an extended resting position and a retracted compressed position. The dampener device 104 includes a cylinder 200, a piston 240, and a dampening apparatus 250. The cylinder 200 includes an inner cylinder surface 202 (see FIG. 3A), an outer cylinder surface 204, a closed end 206, a sealed end 207, an open end 208, an anchoring apparatus 210, a chamber 222 (see FIG. 3A) and a gap 224. The piston 240 includes a piston rod 270, a piston head 272 and a widened end 274 (see FIG. 3A). The piston 240 is sized and shaped to fit and move within the cylinder 200 such that the inner cylinder surface 202 guides the piston 240 to slide in or out therein (i.e., retract and extend).

The anchoring apparatus 210 may extend around the entirety of the outer cylinder surface 204. The anchoring apparatus 210 functions to secure the dampener device 104, specifically the cylinder 200, within the screw hole recess 117 of the hinged door jamb 108 or the recess 122 of the hinged door edge 116. To perform this function the anchoring apparatus 210 may take various shapes and forms, including but not limited to unidirectional ridges, screw threads or the like. As shown in FIG. 2A, the anchoring apparatus 210 includes a plurality of unidirectional ridges 212. The plurality of unidirectional ridges 212 face the same direction so that as the dampening device 104 is inserted into the screw hole recess 117 or the recess 122, the unidirectional ridges 212 reduce the chance of the dampening device 104 to back out and fall away. To insert the cylinder 200 having the plurality of unidirectional ridges 212 a user simply places the closed end 206 into the screw hole recess 117 or recess 122 and pushes the cylinder 200 until the open end 208 is flush with hinge 114, hinged door jamb 108 or hinged edge 116.

In another embodiment, as depicted in FIGS. 2C and 2D, the anchoring apparatus 210 may include a screw thread 214. The screw thread 214 may extend around a portion of the outer cylinder surface 204. As depicted the screw thread 214 may extend around the entire outer cylinder surface 204. To insert the cylinder 200 having the screw thread 214 a user simply places the closed end 206 into the screw hole recess 117 or recess 122 and screws the cylinder 200 until the open end 208 is flush with hinge 114, hinged door jamb 108 or hinged edge 116.

The closed end 206 may be shaped into various shapes and sizes. As shown in FIG. 2A, the closed end 206 may be tapered. The tapering of the closed end 206 may be sized such that the dampening device 104 may easily be inserted into the screw hole recess 117 of the hinge 114 or into the recess 122.

The cylinder 200 may further include an outer flange 216 that extends around the open end 208. As shown in FIG. 2A, the flange 216 may be sized and shaped to prevent the cylinder 200 from being inserted too far into the screw hole recess 117 or the recess 122. The open end 208 may be situated flush with the door hinge 114, the surface of the hinged door jamb 108 or the hinged door edge 116.

The piston head 272 may retract completely within the cylinder 200 or be partially exposed when the dampener device 104 is fully compressed and in the compressed position. The piston head 272 functions as the contact point at which the dampener device 104 makes contact with the moving door 102. To perform this function the piston head 272 may take various shapes and forms, including but not limited to a flattened tip, a rounded tip and a beveled tip or a combination thereof. Due to the relationship between the moving door 102 and the stationary hinged door jamb 108, the angle at which the force of the moving door 102 is exerted upon the dampening device 104 changes as the moving door 102 swings closed. The shape of the piston head 272 functions to mitigate and/or reduce forces directed upon the piston 240 and cylinder 200 that may cause one or both of the piston 240 and cylinder 200 to bow and/or become misshapen as the contact angle between the piston head 272 and door 102 changes as door 102 moves from open to close and vice versa.

For example, as shown in FIG. 2A, the piston head 272 may take the shape of a beveled tip. The beveled tip allows the door 102 to move closer to the closed position before contact is made with the piston head 272 thereby reducing the time the piston 240 and cylinder 200 are subjected to the forces of the moving door 102. In another example, as shown in FIG. 2C, the piston head 272 may take the shape of a flat tip. The flat tip provides added strength to the piston 240 with which to resist the forces of the moving door 102. In yet another example, as depicted in FIG. 2D, the piston head 272 may take the shape of a rounded tip. The rounded tip provides a surface that is uniformly and consistently in contact with the moving door 102 and therefore reduces jerking-like forces of the moving door 102.

Now referring to FIG. 3A, which is a section view along line A-A of the dampener device 104, the piston rod 270 is sized to retract into and extend out of the cylinder 200 via the open end 208. The piston rod 270 and piston head 272 may take various shapes including but not limited to a cylinder, three- or four-sided rod or other multi-sided rod. In one embodiment the piston rod 270 and piston head 272 may be cylindrical with a diameter smaller than the diameter of the inner cylinder surface 202 so that the piston rod 270 and piston head 272 do not make contact with the inner cylinder surface 202. A gap 224 is created in the space between the piston rod 270, piston head 272 and the inner cylinder surface 202. The widened end 274 may be sized to have a diameter such that the widened end 274 snugly touches the inner cylinder surface 202. In some instances, the relationship between the widened end 274 and inner cylinder surface 202 may create a seal, as discussed in further detail below.

As shown the open end 208 of the cylinder 200 may further include an inner flange 218 having a diameter that is sized to snugly receive the piston rod 270 and piston head 272. The inner flange 218 functions to smoothly guide the piston rod 270 and piston head 272 as they are retracting or extending from the cylinder 200. The inner flange 218 further functions to prevent the widened end 274 of the piston rod 270 from falling away from the cylinder 200.

The combined length of the piston rod 270, piston head 272 and widened end 274 may be adapted so that once the piston rod 270 is retracted into the cylinder 200, the tip of the piston head 272 is flush with or slightly extended from the open end 208 of the cylinder 200. The suitable combined length of the piston rod 270, piston head 272 and widened end 274 may also be affected by the size of the dampening apparatus 250.

The dampening apparatus 250 functions to create resistance against external forces which cause the dampening apparatus 250 to compress. The dampening apparatus may take various shapes and forms. In one embodiment the dampening apparatus 250 may include a first and second magnet, 252 and 254, respectively. As shown, the first magnet 252 may be anchored within the cylinder 200 at the sealed end 207, and the second magnet 254 may be attached to the widened end 274 of the piston rod 270. Additionally, the first and second magnets, 252 and 254, are oriented to one another such that like poles are facing each other. In such an orientation, the first and second magnets, 252 and 254, repel one another and results in biasing the piston rod 270 to the extended resting position. In this embodiment, the repelling force created between the like poles of the first and second magnets, 252 and 254, also function to dampen and slow the speed of the moving door 102. For example, as the closing door 102 makes contact with the piston head 272, the closing door 102 exerts force upon the dampening device 104 which causes the piston 240 to retract into the cylinder 200 and the dampening apparatus 250 to compress to a compressed position (FIG. 3B). The repelling forces of the first and second magnets, 252 and 254, increase as they move closer together creating resistance against the exerted forces of the closing door 102 thereby dampening and reducing the speed of the closing door 102.

In another embodiment as depicted in FIG. 3C, the dampening apparatus 250 may include a compression spring 256. The compression spring 256 functions to bias the piston rod 270 in the extended resting position. As shown, the diameter of the compression spring 256 may be sized such that the compression spring 256 is in contact with the inner cylinder surface 202 of the cylinder 200. The length of the compression spring 256 may be adapted such that it extends from the sealed end 207 of the cylinder 200 to the widened end 274 of the piston rod 270 in the extended resting position. For example, as the closing door 102 makes contact with the piston head 272, the closing door 102 exerts force upon the dampening device 104 which causes the piston rod 270 and piston head 272 to retract into the cylinder 200 and the dampening apparatus 250 to compress to a compressed position. As the compression spring 256 becomes compressed, the compression spring 256 works against the closing door 102 and creates resistance against the exerted forces of the closing door 102 thereby dampening and reducing the speed of the closing door 102.

In another embodiment as depicted in FIG. 3D, the dampening apparatus 250 may include a compressible material 258. The compressible material may include, but not limited to, foam, sponge, fluid, gas, silicone, latex, silicone rubber, thermoplastic elastomer, an elastic or rubber material, or a combination thereof. In such an embodiment the chamber 222 of the cylinder 200 may be partially or completely filled with the compressible material 258. For example, as the closing door 102 makes contact with the piston head 272, the closing door 102 exerts force upon the dampening device 104 which causes the piston rod 270 and piston head 272 to retract into the cylinder 200 and the dampening apparatus 250 to compress to a compressed position. The compressible material 258 works against the closing door 102 and creates resistance against the exerted forces of the closing door 102 thereby dampening and reducing the speed of the closing door 102.

The dampener device 104 may be a sealed environment or open to ambient air pressure. As depicted in FIGS. 3A and 3B, the cylinder 200 may be a sealed environment such that a portion of the chamber 222 is sealed and may be filled with air. In a cylinder 200 having a sealed environment the widened end 274 of the piston rod 270 may include a channel (not shown) around the circumference that is sized to receive a gasket (not shown). The gasket functions to create a seal between the chamber 222 and the ambient environment. To further improve the seal of the chamber 222 and movement of the piston rod 270, the gasket may be lubricated. As the dampening device 104 is compressed, the air of the chamber 222 becomes compressed. The compressing air provides resistance to the forces exerted by the moving door 102 upon the dampening device 104 thereby dampening and reducing the speed of the closing door 102.

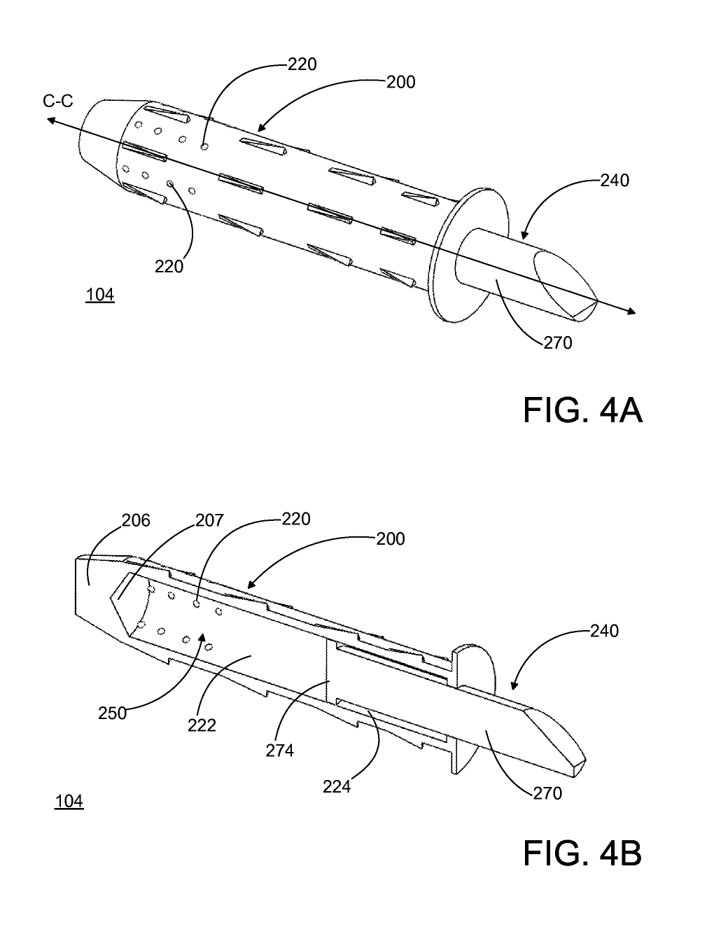

In one embodiment as depicted in FIGS. 4A and 4B, the chamber 222 of the cylinder 200 may be open to ambient air pressure. As shown, the cylinder 200 includes one or more perforations 220 that are open to the ambient environment. The perforations 220 function to allow air to escape from the chamber 222 as the piston rod 270 retracts into the cylinder 200 and the dampening apparatus 250 becomes compressed. In such an embodiment, the amount of resistance provided by the compression and movement of air within the chamber 222 may be modified by the number and size of the perforations 220.

The cylinder 200, piston rod 270 and piston head 272 may be made out of any suitable rigid material. The suitable rigid material is resistant to deforming when force is exerted upon them. For example, suitable material may include, but not limited to metal, plastic, fiberglass, PFTE, or a combination thereof.

The cylinder 200 may be of various suitable thicknesses. A suitable thickness would prevent the cylinder 200 from bending, bowing, twisting or other deformation that would otherwise prevent the piston rod from smoothly retracting and extending therefrom.

Reference is now made to FIG. 5, which is a side view of the dampener device 104 situated in the screw hole recess 117 of the hinge 114. As shown, the diameter of the outer flange 216 of the open end 208 is larger than the screw hole recess 117 and is shaped to be flush with the surface of the hinge 114 when the dampening device 104 is properly inserted in the screw hole recess 117. In a resting position when no force is exerted upon the dampening device 104, the dampening apparatus 250 is not compressed and the piston head 272 and a portion of the piston rod 270 extend out of the cylinder 200 such that the widened end 274 may contact the inner flange 218 or rest somewhere within the cylinder 200. When a user moves the door 102 in order to close it, the hinged door edge 116 moves towards the piston head 272. As contact is made between the hinged door edge 116 and the piston head 272, force is exerted on the piston head 272 and the piston rod 270 retracts and moves into the cylinder 200. The dampening apparatus 250 compresses as the piston rod 270 retracts and moves into the cylinder 200. Resistance is created by the dampening apparatus 250 as it compresses, and the resistance acts against the piston 240 and the moving door 102 and the exerted forces such that the retracting movements of the piston 240 and door 102 are dampened and slowed. The dampening of the closing door 102 causes the door 102 to close slowly and safely. As the dampening apparatus 250 compresses and the door 102 closes, the piston rod 270 retracts into the cylinder 200 until the piston head 272 may be completely or partially retracted within the cylinder 200, and door 102 is in the compressed position.

When a user desires to open the door 102, the user simply pushes and/or releases the door knob assembly 120 such that the door 102 swings open. As the hinged door edge 116 moves away from the dampening device 104, the dampening apparatus 250 decompresses and the piston rod 270 and piston 272 extend back out of the cylinder 200 into the resting position.

As shown in FIG. 6, the dampener device 104 may be situated in the hinged door jamb 108 at a position away from the hinge 114. In such instances, the recess 122 may be pre-drilled and sized so that the anchoring apparatus 210 may be securely anchored within thereby preventing the dampening device 104 to fall away.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A dampening system, comprising:
a door frame comprising a hinged jamb;
a door panel comprising a hinged edge, the door panel sized and shaped to engage the door frame;
at least one hinge comprising a first side of the hinge attached along the hinged jamb, and a second side of the hinge attached along the hinged edge, wherein the hinge operates to allow the door panel to move relative to the door frame; and
at least one dampener comprising a cylinder, a piston and a compressible dampening apparatus moveable within said cylinder, the at least one dampener secured within a recess of one of the hinged edge or hinged jamb such that a portion of the piston extends from the recess,
wherein the dampener operates to dampen a closing motion of the door panel about the hinge.

2. The dampening system according to claim 1, wherein the dampener further comprises an anchoring apparatus, the anchoring apparatus integrated with a portion of an outer surface of the cylinder and operating to secure the dampener within the recess.

3. The dampening system according to claim 2, wherein the anchoring apparatus comprises a plurality of spaced apart ridges, the ridges oriented unidirectionally to one another.

4. The dampening system according to claim 2, wherein the anchoring apparatus comprises a screwthread.

5. The dampening system according to claim 2, wherein the recess is a screw hole that previously held a screw of the hinge.

6. The dampening system according to claim 2, wherein the recess is a hole at a position on the hinged jamb of the door frame or the hinged edge of the door panel and located away from the hinge.

7. The dampening system according to claim 1, wherein the cylinder comprises a chamber, a closed end and an open end, and wherein the chamber is sized to receive the dampening apparatus and a portion of the piston.

8. The dampening system according to claim 7, wherein the piston comprises a piston rod, a piston head and a widened end.

9. The dampening system according to claim 8, wherein the open end further comprises an inner flange that is sized and shaped to receive and guide the piston rod and retain the widened end within the cylinder.

10. The dampening system according to claim 7, wherein the open end further comprises an outer flange operating to orient the dampener within the recess.

11. The dampening system according to claim 7, wherein the closed end is tapered and is operable to guide the dampener into the recess.

12. The dampening system according to claim 8, wherein the dampening apparatus comprises a compression spring.

13. The dampening system according to claim 8, wherein the dampening apparatus comprises a compressible material selected from one or a combination of foam, sponge, fluid, gas, silicone, latex, silicone rubber, thermoplastic elastomer and rubber.

14. The dampening system according to claim 8, wherein the dampening apparatus comprises a first magnet attached to the closed end and a second magnet attached to the widened end, wherein the first and second magnets are oriented such that like poles are facing each other.

15. The dampening system according to claim 8, wherein the cylinder further comprises one or more perforations operable to allow air to escape from the chamber.

16. The dampening system according to claim 8, wherein the piston head is in a shape selected from the group consisting of:
flat ended, rounded, angled, slanted and pointed.

17. A dampener comprising:
a cylinder comprising a chamber having an interior wall, a sealed end, a closed end and an open end;
a piston comprising a piston rod and widened end, the widened end and the piston rod moveable within said chamber such that the widened end is sized to maintain a constant contact with the wall of the chamber;
a dampening apparatus moveable within said chamber;
an anchoring apparatus integrated with a portion of an outer surface of the cylinder and operates to secure the dampener in a recess of an object; and
wherein the piston and dampening apparatus are arranged within said chamber so that the dampening apparatus is positioned between the closed end and the widened end.

18. The dampener according to claim 17, wherein the open end further comprises an inner flange having a diameter smaller than the diameter of the chamber, the inner flange sized and shaped to receive and guide the piston rod and retain the widened end within the cylinder.

19. The dampener according to claim 17, wherein the open end further comprises an outer flange operating to orient the dampener within the recess.

20. The dampener according to claim 17, wherein the closed end is tapered and is operable to guide the dampener into the recess.

21. The dampener according to claim 17, wherein the dampening apparatus comprises a compression spring, said compression spring operable to create resistance forces as the compression spring is compressed.

22. The dampener according to claim 17, wherein the dampening apparatus comprises a compressible material selected from one or a combination of foam, sponge, fluid, gas, silicone, latex, silicone rubber, thermoplastic elastomer and rubber, wherein the compressible material operates to create resistance forces as the compressible material is compressed.

23. The dampener according to claim 17, wherein the dampening apparatus comprises a first magnet attached to the sealed end and a second magnet attached to the widened end, wherein the first and second magnets are oriented such that like poles are facing each other and operate to create resistance forces as the magnets are forced towards one another.

24. The dampener according to claim 17, wherein the anchoring apparatus comprises a plurality of spaced apart ridges, the ridges oriented unidirectionally to one another.

25. The dampener according to claim 17, wherein the anchoring apparatus comprises a screwthread.

26. The dampener according to claim 17, wherein the piston head is in a shape selected from the group consisting of: flat ended, rounded, angled, slanted and pointed.

27. The dampener according to claim 17, wherein the cylinder further comprises one or more perforations operable to allow air to escape from the chamber.

28. The dampener according to claim 17, wherein the object is a door frame or a door panel.
